(19) United States
(12) Patent Application Publication
(10) Pub. No.: US 2013/0343054 A1
(43) Pub. Date: Dec. 26, 2013

(54) LIGHT EMITTING APPARATUS

(71) Applicant: GIO Optoelectronics Corp., Tainan City (TW)

(72) Inventor: CHIA-HO YANG, Tainan City (TW)

(21) Appl. No.: 13/924,524

(22) Filed: Jun. 21, 2013

(30) Foreign Application Priority Data
Jun. 25, 2012 (TW) 101122676

(51) Int. Cl. F21V 23/00

(52) U.S. Cl. CPC F21V 23/00
USPC 362/249.01; 362/382; 362/257

(57) ABSTRACT

A light emitting apparatus includes at least a light emitting module, and the light emitting module comprises a supporting element, a flexible circuit board and at least a light emitting element. The supporting element has a first surface and a second surface which are opposite to each other. The flexible circuit board includes a first light emitting portion and at least an electrical connection portion. The light emitting portion is disposed on the first surface of the supporting element, and the electrical connection portion is bent to the side of the second surface of the supporting element. The light emitting element is disposed at the light emitting portion.

### CROSS REFERENCE TO RELATED APPLICATIONS

This Non-provisional application claims priority under 35 U.S.C. §119(a) on Patent Application No(s). 101122676 filed in Taiwan, Republic of China on Jun. 25, 2012, the entire contents of which are hereby incorporated by reference.

### BACKGROUND OF THE INVENTION

1. Field of Invention

The invention relates to a light emitting apparatus.

2. Related Art

Since light emitting diodes (LED) have been commercialized, they are widely applied to various appliances in our daily life, such as household appliances, indicator lights and light sources, due to their advantages like long lifespan, less power consumption and less heat generated. Recently, with the development of multicolor and high brightness, LEDs are further applied to outdoor display apparatuses, such as large outdoor billboards and traffic lights.

As shown in FIG. 1, a conventional light emitting apparatus 5 includes a circuit board 51, a plurality of light emitting elements 52 and a connector 53. The light emitting elements 52 are disposed on the circuit board 51. The connector 53 is disposed at the edge of the circuit board 51 and electrically connected with other electronic devices (such as another circuit board) by plural wires 531. The connector 53 can transmit the driving signals through the wires 531 to the circuit board 51 to drive the light emitting elements 52 to emit light.

Because the wires 531 go around the edge of the circuit board 51, the whole appearance will not be pleasing. Besides, when a plurality of the light emitting apparatuses 5 are pieced together to form a large-scale display apparatus, the wires 531 will obstruct the assembling, and therefore a gap will exist between the adjacent light emitting apparatuses 5 so as to lower the display quality. Furthermore, the circuit board 51 is generally a resin circuit board and can not be bent due to the rigidity, so that the circuit board 51 needs to undergo an edge-rubbing process to reduce its edge when the circuit boards 51 are assembled to form a large-scale display apparatus. Accordingly, not only the cost is increased, but also the requirement of reducing the pixel pitch can not be satisfied. Therefore, it is an important subject to provide a light emitting apparatus that is configured with an innovative structure to achieve the seamless assembling.

### SUMMARY OF THE INVENTION

In view of the foregoing subject, an objective of the invention is to provide a light emitting apparatus that can achieve the seamless assembling.

To achieve the above objective, a light emitting apparatus according to the invention includes at least a light emitting module, and the light emitting module comprises a supporting element, a flexible circuit board and at least a light emitting element. The supporting element has a first surface and a second surface which are opposite to each other. The flexible circuit board includes a first light emitting portion and at least an electrical connection portion. The light emitting portion is disposed on the first surface of the supporting element, and the electrical connection portion is bent to the side of the second surface of the supporting element. The light emitting element is disposed at the light emitting portion.

In one embodiment, the area of the flexible circuit board is larger than that of the first surface of the supporting element, and the portion of the flexible circuit board beyond the supporting element is the electrical connection portion.

In one embodiment, when the light emitting apparatus includes a plurality of the light emitting modules, the light emitting modules are disposed side by side.

In one embodiment, a part of the electrical connection portion is disposed at the junction of the supporting elements of the adjacent light emitting modules.

In one embodiment, the light emitting modules are disposed as a one-dimensional or two-dimensional array.

In one embodiment, when there are a plurality of the light emitting elements, they are disposed as a one-dimensional or two-dimensional array.

In one embodiment, the light emitting elements of the adjacent light emitting modules are disposed as a one-dimensional or two-dimensional array.

In one embodiment, the material of the supporting element includes metal, plastic material, glass or ceramic material.

In one embodiment, when the flexible circuit board includes a plurality of the electrical connection portions, they are disposed on the side of the second surface and overlap each other or not.

In one embodiment, the electrical connection portion includes a circuit layer, an integrated circuit, or a connector.

In one embodiment, the light emitting apparatus further comprises at least a cover element covering the flexible circuit board.

In one embodiment, the light emitting module further includes a cover element covering the flexible circuit board.

In one embodiment, the cover element is configured with a patterned light blocking layer or a plurality of through holes.

In one embodiment, when there are a plurality of the cover elements, each of them has an engaging structure for connecting to the adjacent cover element.

In one embodiment, the cover element is configured with a patterned light blocking layer or a plurality of through holes.

In one embodiment, when the light emitting apparatus includes a plurality of the light emitting modules, each of the supporting elements has an engaging structure for connecting to the adjacent supporting element.

In one embodiment, the supporting element includes a plate and at least an alignment portion, and the alignment portion is disposed on the second surface of the supporting element.

In one embodiment, the alignment portion is a wall, pillar, bump, hole or recess.

In one embodiment, a tail width of the electrical connection portion is less than a side length of the supporting element.

In one embodiment, the electrical connection portion is bent to the second surface thereunder or to the second surface of the supporting element of another light emitting module.

In one embodiment, when comprising a plurality of the light emitting modules, the light emitting apparatus further comprises at least a connecting element connecting to the alignment portions of the adjacent light emitting modules.

As mentioned above, in the light emitting apparatus according to this invention, the flexible circuit board with the light emitting element thereon can be bent to generate the light emitting portion and the electrical connection portion, and the electrical connection portion is bent to the side of the second surface of the supporting element, so that the light emitting portions of the adjacent flexible circuit boards are closer to each other so as to connect to each other compactly. Thereby, the flexible circuit boards of the light emitting apparatus can be connected to each other (nearly) seamlessly. Therefore, the interval between the adjacent light emitting elements can be reduced a lot. Accordingly, the number of the light emitting elements in a unit area is increased, and therefore the light emitting intensity and the pixel number can be increased. Furthermore, the supporting element of the light emitting apparatus of the invention can strengthen the structural firmness and provide various connection manners. For example, the adjacent supporting elements can be connected to each other by the engaging structures.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a schematic diagram of a conventional light emitting apparatus;

FIG. 2A is a schematic exploded diagram of a light emitting apparatus according to an embodiment of this invention;

FIG. 2B is a schematic diagram of the light emitting apparatus in FIG. 2A;

FIGS. 3A to 3C are schematic diagrams of variations of the flexible circuit board according to this invention;

FIGS. 4A to 4D are schematic diagrams of variations of the light emitting module according to this invention;

FIGS. 5A and 5B are schematic side views of a plurality of the light emitting modules disposed side by side according to an embodiment of this invention;

FIGS. 6A and 6B are schematic diagrams of the supporting elements connected to each other by a connecting element according to the invention;

FIG. 7 is a schematic exploded diagram of a light emitting module according to another embodiment of the invention;

FIGS. 8A and 8B are schematic diagrams of different cover elements according to this invention;

FIG. 9 is a schematic diagram of the light emitting apparatus including a single cover element according to this invention; and

FIG. 10 is a schematic diagram of the cover elements of the light emitting apparatus connected to each other by the engaging structures according to this invention.

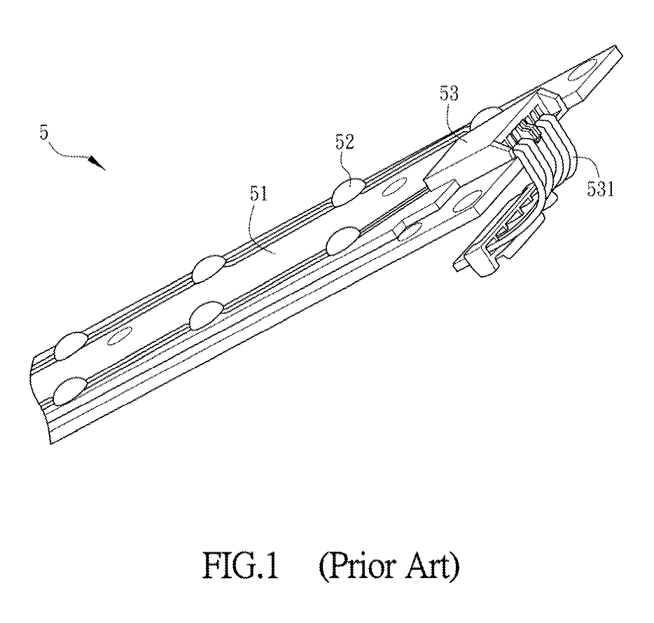

### DETAILED DESCRIPTION OF THE INVENTION

The present invention will be apparent from the following detailed description, which proceeds with reference to the accompanying drawings, wherein the same references relate to the same elements.

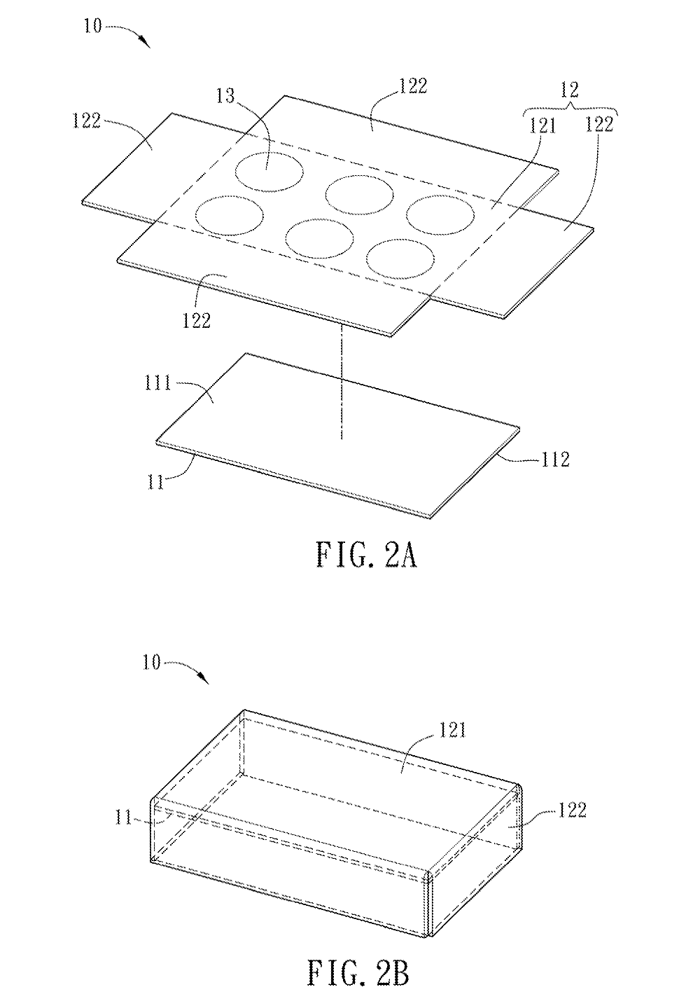

FIG. 2A is a schematic exploded diagram of a light emitting apparatus according to an embodiment of this invention, and FIG. 2B is a schematic diagram of the light emitting apparatus in FIG. 2A. As shown in FIGS. 2A and 2B, the light emitting apparatus includes at least a light emitting module 10, which includes a supporting element 11, a flexible circuit board 12 and at least a light emitting element 13. Herein, the light emitting apparatus can function as an illumination apparatus, a display apparatus, a billboard, or a backlight module, for example.

The supporting element 11 of this embodiment is not limited in shape, which has a rectangular shape, a circular shape or other geometric shapes for example. Herein, the supporting element 11 has a rectangular shape as an embodiment. The supporting element 11 of this embodiment is also not limited in material. The material thereof includes metal, plastic material, glass or ceramic material for example. The supporting element 11 is preferably capable of rigidity. The supporting element 11 also can be a circuit board. The supporting element 11 has a first surface 111 and a second surface 112 which are opposite to each other.

The flexible circuit board 12 has a light emitting portion 121 and at least an electrical connection portion 122. The light emitting portion 121 is used to emit light and disposed on the first surface 111 of the supporting element 11. The electrical connection portion 122 is bent so as to reach the side of the second surface 112 of the supporting element 11. After bent, the electrical connection portion 122 can be parallel to the second surface 112, or forms an acute, right or obtuse angle with the second surface 112. Herein for example, the electrical connection portion 122 forms a right angle with the second surface after bent. The material of the flexible circuit board 12 includes metal, resin, glass or ceramic material for example. In this embodiment, the area of the flexible circuit board 12 is larger than that of the first surface 111 of the supporting element 11. The portion of the flexible circuit board 12 beyond the supporting element 11 is the electrical connection portion 122 while the portion of the flexible circuit board 12 corresponding to the first surface 111 of the supporting element 11 is the light emitting portion 121. Herein, the electrical connection portions 122 are disposed at the edges of the light emitting portion 121. The electrical connection portion 122 includes, for example, a circuit layer, an integrated circuit (IC), or a connector, and is able to electrically connect to an external circuit or the electrical connection portions of other light emitting modules for driving the light emitting element 13 to emit light.

The light emitting element 13 is disposed at the light emitting portion 121, and can be a light emitting diode, organic light emitting diode or other electroluminescent elements for example. Furthermore, the light emitting element 13 can be a die or a package. The light emitting elements 13 can be disposed as a one-dimensional or two-dimensional array, and is disposed as a two-dimensional array here for example.

By bending the electrical connection portion 122, the single light emitting module 10 can be reduced in dimensions, and therefore the light emitting apparatus also can be reduced in dimensions.

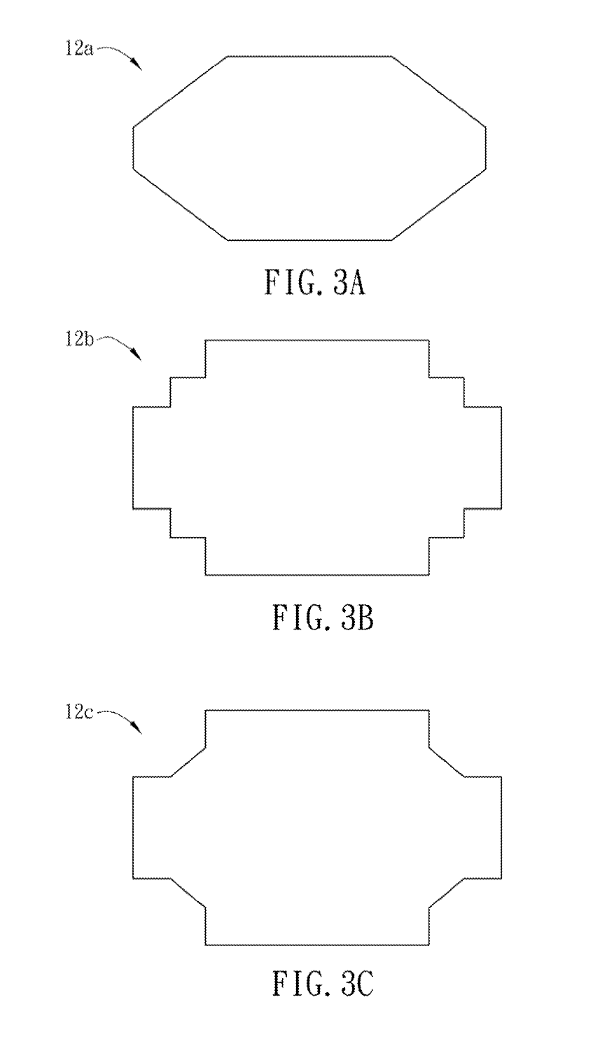

FIGS. 3A to 3C are schematic diagrams of variations of the flexible circuit board according to this invention. As shown in FIGS. 3A to 3C, the flexible circuit boards 12a to 12c have different shapes, and the key point is that the area of each of the flexible circuit boards 12a to 12c is larger than that of the supporting element so that a portion of each of the flexible circuit boards 12a to 12c can be bent to reach the side of the second surface of the supporting element for serving as the electrical connection portion.

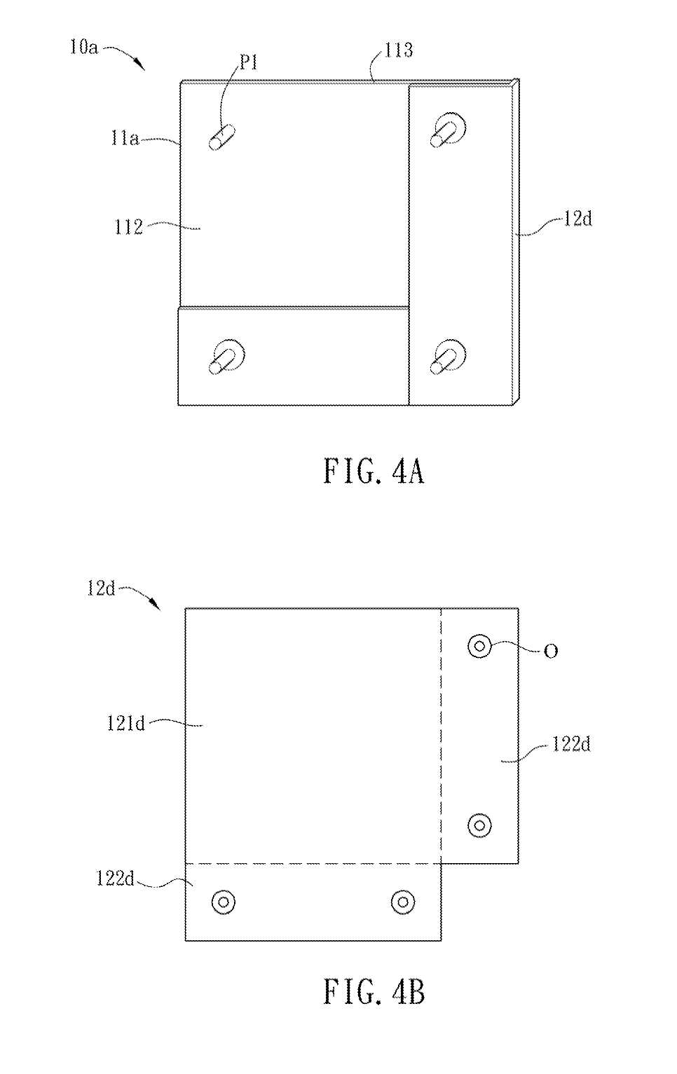

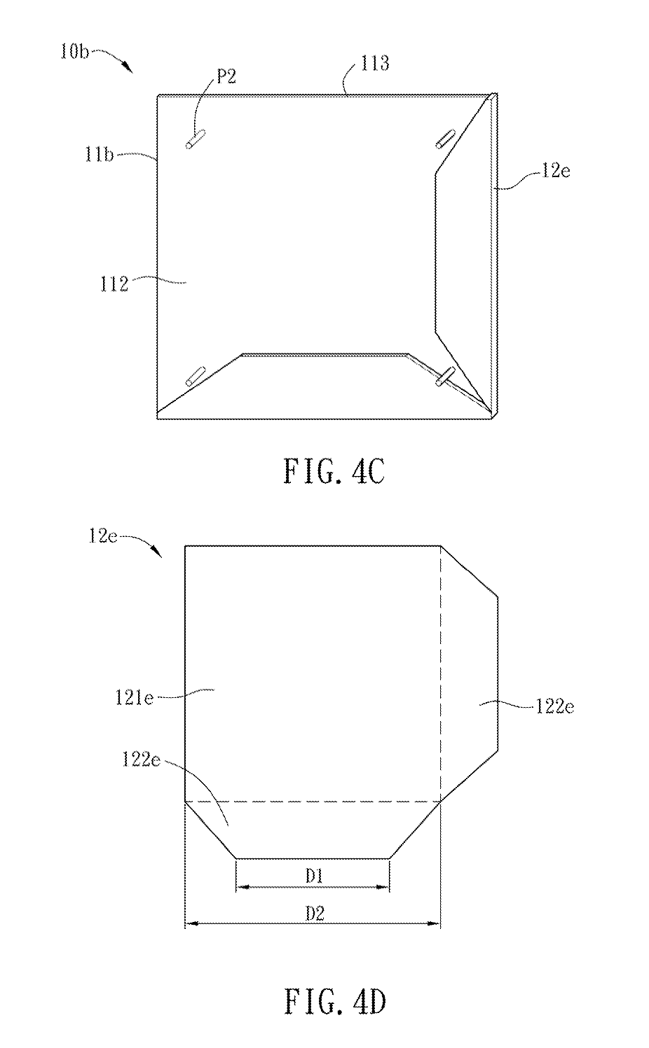

FIGS. 4A and 4B are schematic diagrams of the light emitting module of another embodiment of this invention. FIG. 4A is a schematic bottom view of the light emitting module 10a, and FIG. 4B is an exploded diagram of a flexible circuit board 12d of the light emitting module 10a. As shown in FIGS. 4A and 4B, the light emitting module 10a includes a supporting element 11 a and a flexible circuit board 12d, and the flexible circuit board 12d includes a light emitting portion 121d and two electrical connection portions 122d. When the electrical connection portions 122d are bent to the second surface 112 of the supporting element 11a, they come close to the side of the second surface and overlap each other. Besides, the supporting element 11a includes a plate 113 and at least an alignment portion P1 (four alignment portions P1 in this embodiment). The alignment portion P1 is disposed on the second surface 112 of the supporting element 11a, and can be a wall, pillar, bump, hole, recess or other kinds of alignment structure. Herein, the alignment portion P1 is a pillar as an embodiment. Besides, the part of the electrical connection portion 122d corresponding to the alignment portion P1 can have, for example, a hole, opening or slit for connecting to the alignment portion P1. Herein, the electrical connection portion 122d has an opening O exemplarily corresponding to the alignment portion P1, and the alignment portion P1 can pass through the opening O so as to position the bent electrical connection portion 122d. After positioned, the electrical connection portion 122d can be further fixed to the second surface 112 of the supporting element 11a by an adhesive agent. Otherwise, if the alignment portion P1 has a flat head like that of a thumbtack, it also can fix the electrical connection portion 122d.

FIGS. 4C and 4D are schematic diagrams of the light emitting module of another embodiment of this invention. FIG. 4C is a schematic bottom view of the light emitting module 10b, and FIG. 4D is an exploded diagram of a flexible circuit board 12e of the light emitting module 10b. As shown in FIGS. 4C and 4D, the light emitting module 10b includes a supporting element 11b and a flexible circuit board 12e, and the flexible circuit board 12e includes a light emitting portion 121e and two electrical connection portions 122e. When the electrical connection portions 122e are bent to the second surface 112 of the supporting element 11b, they come close to the side of the second surface 112 and don't overlap each other. Besides, the supporting element 11b includes a plate 113 and at least an alignment portion P2 (four alignment portions P2 in this embodiment). The alignment portion P2 is disposed on the second surface 112 of the supporting element 11b, and can be a wall, pillar, bump, hole, recess or other kinds of alignment structure. Herein, the alignment portion P2 is a pillar as an embodiment. Besides, the electrical connection portions 122e just go around the alignment portions P2 when bent to the second surface 112 of the supporting element 11b. Furthermore, a tail width D1 of the electrical connection portion 122e is less than a side length D2 of the supporting element 11b, so that the electrical connection portion 122e has a trapezoid or triangular shape. Herein, the electrical connection portion 122e has a trapezoid shape as an embodiment.

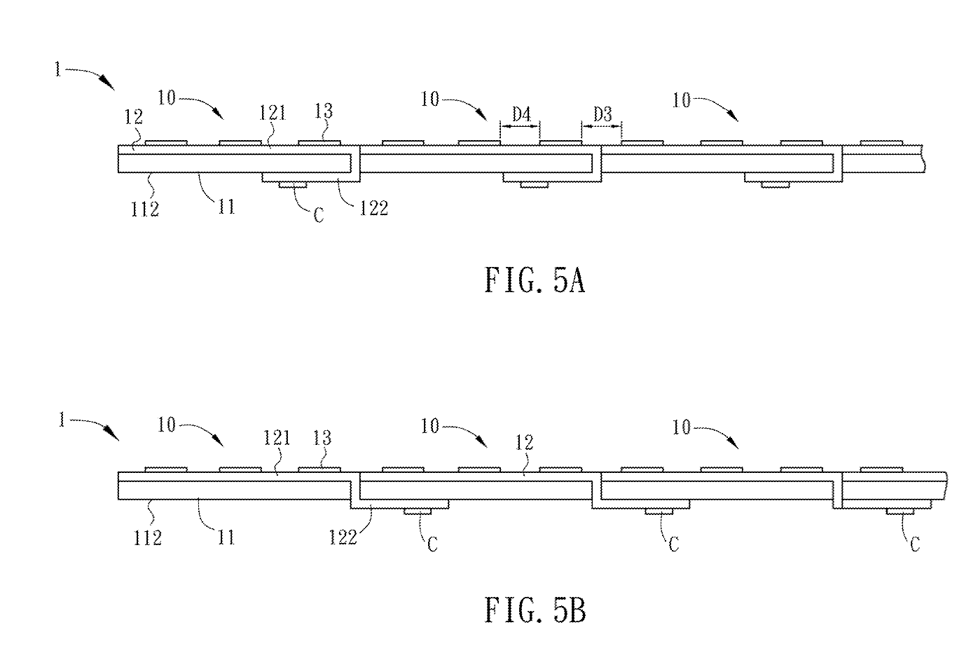

When the light emitting apparatus includes a plurality of the light emitting modules, the light emitting modules can be assembled and disposed side by side. FIGS. 5A and 5B are schematic side views of a plurality of the light emitting modules 10 connected to each other according to an embodiment of this invention. As shown in FIGS. 5A and 5B, the light emitting apparatus 1 includes a plurality of light emitting modules 10, and the light emitting modules 10 are connected to each other, for example, nearly seamlessly or with a seam therebetween. Herein, they are connected to each other nearly seamlessly as an embodiment. Besides, the light emitting modules 10 can be disposed as a one-dimensional or two-dimensional array.

When the light emitting modules 10 are connected to each other, a part of the electrical connection portion 122 is disposed at the junction of the supporting elements 11 of the adjacent light emitting modules 10. In other words, when the supporting element 11 is a rectangular plate, a part of the electrical connection portion 122 is disposed at an edge of the supporting element 11 of the next light emitting module 10. Furthermore, the electrical connection portion 122 can be bent around an edge of the supporting element 11 to reach the second surface 112 of the supporting element 11 thereunder (as shown in FIG. 5A) or to reach the second surface 112 of the supporting element 11 of another light emitting module (as shown in FIG. 5B). Herein, the electrical connection portion 122 has a connector C for example, which can be electrically connected to an external circuit or the electrical connection portions of other light emitting modules for driving the light emitting element 13 to emit light. By bending the electrical connection portion 122, a single light emitting module 10 can be reduced in dimensions so that the adjacent light emitting portions 121 can be connected to each other compactly. The light emitting elements 13 on the light emitting portion 121 can be disposed as a one-dimensional or two-dimensional array and spaced equally. Besides, the interval D3 between two of the light emitting elements closest to each other on the adjacent light emitting portions 121 can be the same as the interval D4 between the adjacent light emitting elements on the same light emitting portion, and thus the display quality can be enhanced (as shown in FIG. 5A).

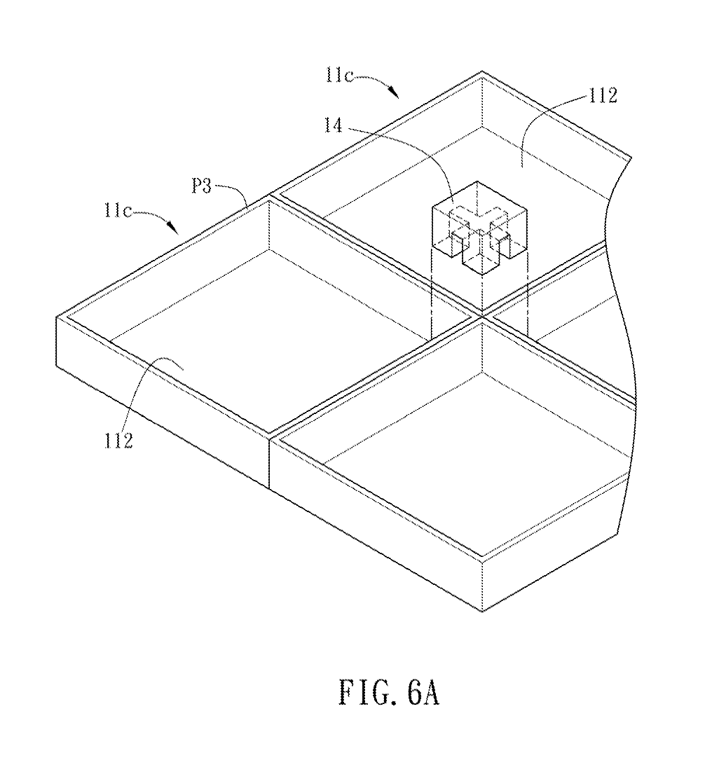

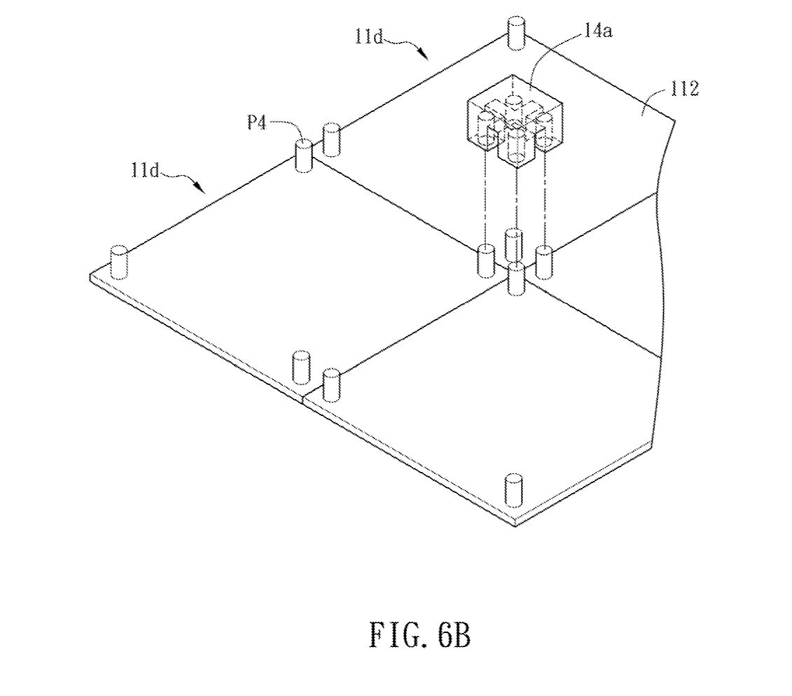

When a plurality of the light emitting modules are assembled, the connection manner thereof can be implemented variously. For example, as shown in FIG. 6A, there are several supporting elements 11c connected to each other, and each of them has at least an alignment portion P3, which is a short wall exemplarily. Herein, the short wall is disposed at the edge of the second surface 112 of the supporting element 11c for example, and four adjacent short walls can function as a frame. The light emitting apparatus can further include at least a connecting element 14, which connects to the adjacent alignment portions P3. Herein, the connecting element 14 is disposed at the center of the four adjacent supporting elements 11c and locks the corresponding alignment portions P3, so that the supporting elements 11c are fixed and positioned. In the case of FIG. 6B, mainly different from the case of FIG. 6A, the alignment portion P4 of the supporting element 11d is a pillar exemplarily, and the connecting element 14a is disposed at the center of the four adjacent supporting elements 11d and locks the corresponding alignment portions P4, so that the supporting elements 11d are fixed and positioned.

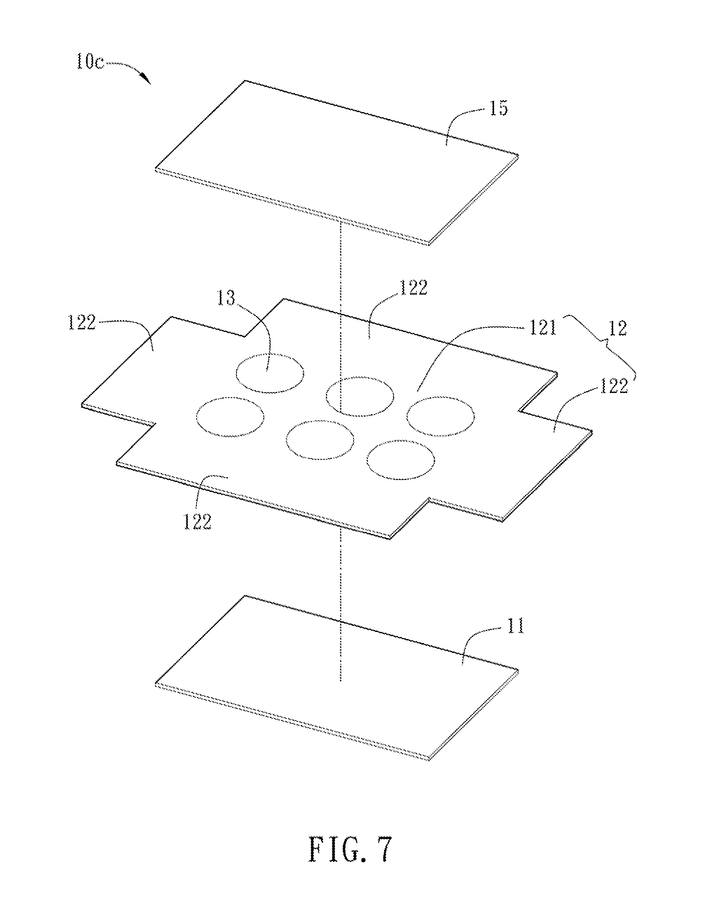

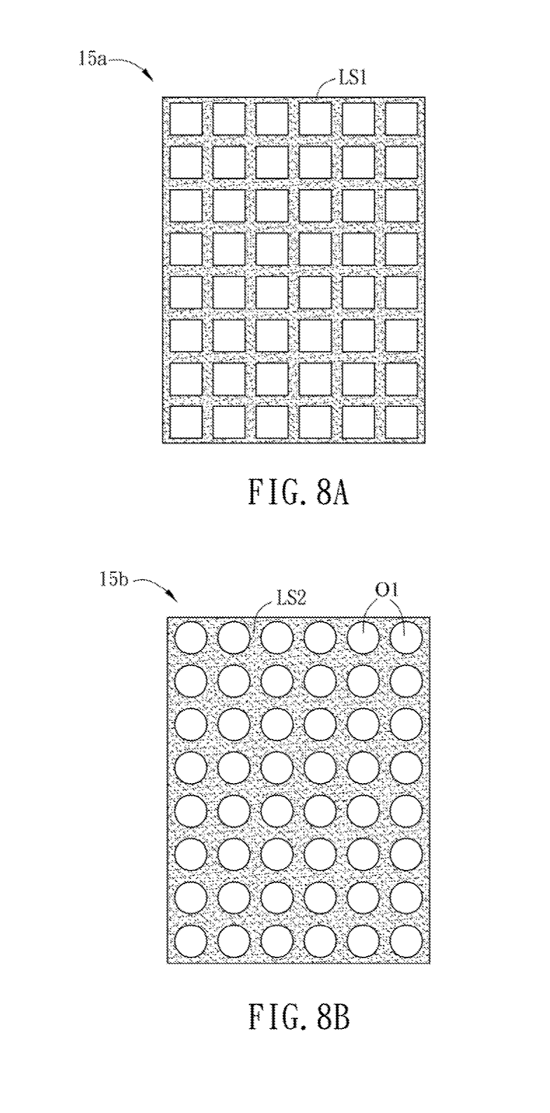

FIG. 7 is a schematic exploded diagram of a light emitting module 10c according to another embodiment of the invention. Mainly different from the above embodiments, the light emitting module 10c further includes a cover element 15, which covers the flexible circuit board 12. The cover element 15 can be made by transparent material for example, such as glass or plastic material. The cover element 15 can be used to protect the flexible circuit board 12. The cover element 15 also can be configured with a patterned light blocking layer or a plurality of through holes. As shown in FIGS. 8A and 8B, the cover elements 15a and 15b are configured with different patterned light blocking layers LS1 and LS2. The cover element 15a has a plurality of rectangular light output regions, and the cover element 15b has a plurality of circular light output regions. Besides, the cover element 15b is also configured with a plurality of through holes O1, which are disposed outside the patterned light blocking layer LS2 for outputting the light emitted by the light emitting elements.

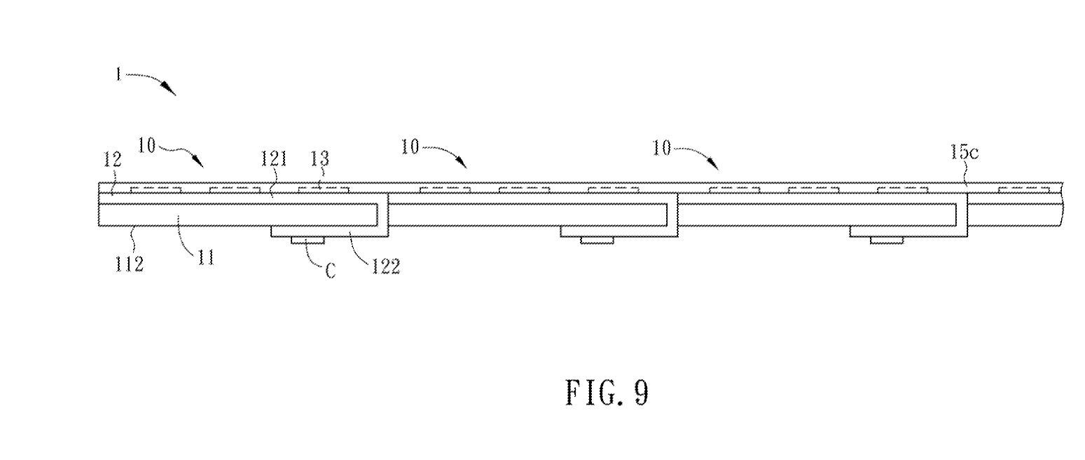

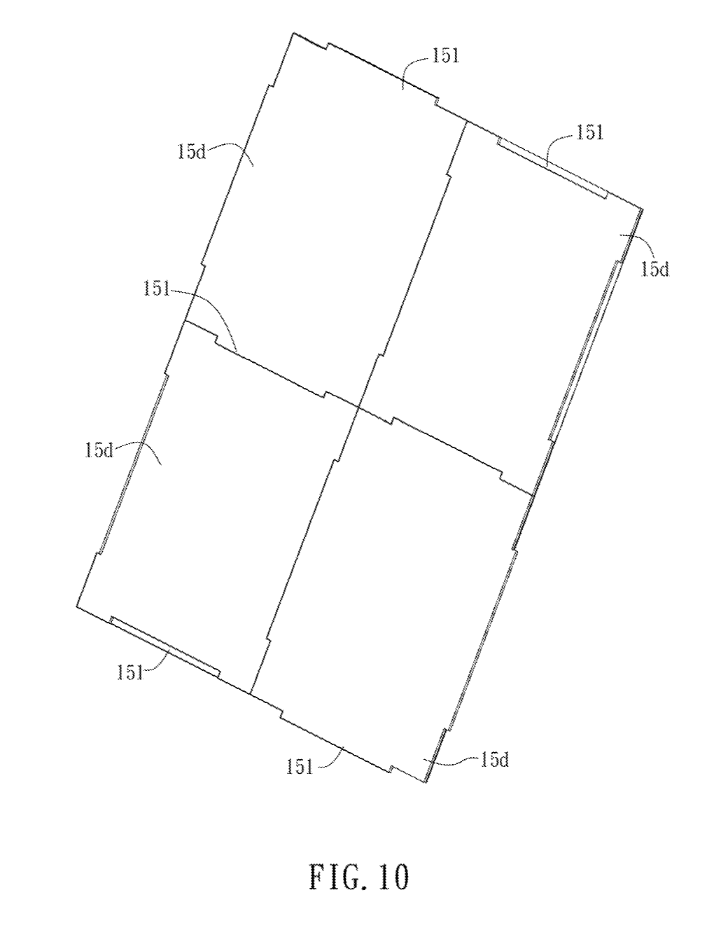

Besides the case that each of the light emitting modules has a cover element, another case also can be included by this invention that the entire light emitting apparatus has a single cover element covering the flexible circuit boards of the light emitting modules. As shown in FIG. 9, the light emitting apparatus 1 includes a plurality of light emitting modules 10 connected to each other, and further includes a cover element 15c covering the flexible circuit boards 12 of the light emitting modules 10. For example, the cover element 15c covers the light emitting portions 121 of the light emitting modules 10 for protecting the flexible circuit boards 12.

Besides, when there are a plurality of cove elements, each of them can have an engaging structure for the mutual connection. As shown in FIG. 10, each of the cover elements 15d has at least an engaging structure 151 for connecting to the adjacent cover element 15d. Herein, the engaging structure 151 can be shaped like a recess or protrusion so as to connect to the adjacent cover element 15d. Likewise, when there are a plurality of supporting elements, each of them can have at least an engaging structure (not shown) also for the mutual connection. The engaging structures of the supporting elements can be known by referring to those of the cover elements, and therefore they are not described here for conciseness.

In summary, in the light emitting apparatus according to this invention, the flexible circuit board with the light emitting element thereon can be bent to generate the light emitting portion and the electrical connection portion, and the electrical connection portion is bent to the side of the second surface of the supporting element, so that the light emitting portions of the adjacent flexible circuit boards are closer to each other so as to connect to each other compactly. Thereby, the flexible circuit boards of the light emitting apparatus can be connected to each other (nearly) seamlessly. Therefore, the interval between the adjacent light emitting elements can be reduced a lot. Accordingly, the number of the light emitting elements in a unit area is increased, and therefore the light emitting intensity and the pixel number can be increased. Furthermore, the supporting element of the light emitting apparatus of the invention can strengthen the structural firmness and provide various connection manners. For example, the adjacent supporting elements can be connected to each other by the engaging structures.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A light emitting apparatus including at least a light emitting module that comprises:
a supporting element having a first surface and a second surface which are opposite to each other;
a flexible circuit board including a first light emitting portion and at least an electrical connection portion, wherein the light emitting portion is disposed on the first surface of the supporting element, and the electrical connection portion is bent to the side of the second surface of the supporting element; and
at least a light emitting element disposed at the light emitting portion.

2. The light emitting apparatus as recited in claim 1, wherein the area of the flexible circuit board is larger than that of the first surface of the supporting element, and the portion of the flexible circuit board beyond the supporting element is the electrical connection portion.

3. The light emitting apparatus as recited in claim 1, wherein when the light emitting apparatus includes a plurality of the light emitting modules, the light emitting modules are disposed side by side.

4. The light emitting apparatus as recited in claim 3, wherein a part of the electrical connection portion is disposed at the junction of the supporting elements of the adjacent light emitting modules.

5. The light emitting apparatus as recited in claim 3, wherein the light emitting modules are disposed as a one-dimensional or two-dimensional array.

6. The light emitting apparatus as recited in claim 1, wherein when there are a plurality of the light emitting elements, they are disposed as a one-dimensional or two-dimensional array.

7. The light emitting apparatus as recited in claim 3, wherein the light emitting elements of the adjacent light emitting modules are disposed as a one-dimensional or two-dimensional array.

8. The light emitting apparatus as recited in claim 1, wherein when the flexible circuit board includes a plurality of the electrical connection portions, they are disposed on the side of the second surface and overlap each other or not.

9. The light emitting apparatus as recited in claim 1, wherein the electrical connection portion includes a circuit layer, an integrated circuit, or a connector.

10. The light emitting apparatus as recited in claim 1, further comprising:
at least a cover element covering the flexible circuit board.

11. The light emitting apparatus as recited in claim 1, wherein the light emitting module further includes a cover element covering the flexible circuit board.

12. The light emitting apparatus as recited in claim 10, wherein the cover element is configured with a patterned light blocking layer or a plurality of through holes.

13. The light emitting apparatus as recited in claim 10, wherein when there are a plurality of the cover elements, each of them has an engaging locking structure for connecting to the adjacent cover element.

14. The light emitting apparatus as recited in claim 11, wherein the cover element is configured with a patterned light blocking layer or a plurality of through holes.

15. The light emitting apparatus as recited in claim 1, wherein when the light emitting apparatus includes a plurality of the light emitting modules, each of the supporting elements has an engaging structure for connecting to the adjacent supporting element.

16. The light emitting apparatus as recited in claim 1, wherein the supporting element includes a plate and at least an alignment portion, and the alignment portion is disposed on the second surface of the supporting element.

17. The light emitting apparatus as recited in claim 16, wherein the alignment portion is a wall, pillar, bump, hole or recess.

18. The light emitting apparatus as recited in claim 1, wherein a tail width of the electrical connection portion is less than a side length of the supporting element.

19. The light emitting apparatus as recited in claim 4, wherein the electrical connection portion is bent to the second surface thereunder or to the second surface of the supporting element of another light emitting module.

20. The light emitting apparatus as recited in claim 16, when comprising a plurality of the light emitting modules, further comprising:
at least a connecting element connecting to the alignment portions of the adjacent light emitting modules.
